(19) United States
(12) Patent Application Publication
(10) Pub. No.: US 2010/0102071 A1
(43) Pub. Date: Apr. 29, 2010

(54) METHOD FOR FIXING A VALVE ASSEMBLY TO A CONTAINER

(76) Inventors: Albert Wauters, Destelbergen (BE); Iain McDerment, Hertfordshire (GB)

Correspondence Address: Levy & Grandinetti, P.O. Box 18385, Washington, DC, 20036, US

(21) Appl. No.: 12/449,487

(22) PCT Filed: Feb. 12, 2008
(86) PCT No.: PCT/EP2008/051687

§ 371 Date: Aug. 11, 2009

(30) Foreign Application Priority Data
Feb. 12, 2007 (GB) 0702673.5
Dec. 14, 2007 (GB) 0724457.7

(51) Int. Cl. B65D 8/04; B23K 26/00

(52) U.S. Cl. 220/669; 219/121.64

(57) ABSTRACT

A method for fixing a valve assembly to a container, the container comprising a neck portion in a first thermoplastic material and the valve assembly comprising a ring of a second thermoplastic material, the method comprising positioning the valve assembly on or in the container's neck portion to form an interface between the thermoplastic ring and the container's neck portion, characterized in that the method further comprises laser welding the thermoplastic ring to the container's neck portion.

### FIELD OF THE INVENTION

The present invention concerns container with valve assembly, in particular an assembly comprising a container with a neck portion of thermoplastic material and a valve assembly fixed thereto.

### BACKGROUND OF THE INVENTION

Containers and especially kegs for beverages comprise a neck portion with a valve assembly fixed thereto. Various solutions are known for realizing the fixation of the valve assembly to the neck portion of the container, such as snap fit, threads and welding.

While thread fixation and snap fits are known for containers in steel or in a thermoplastic material, welding is a typical solution for containers in steel (EP0025682, U.S. Pat. No. 4,231,488).

Fixation of the valve assembly to the neck portion by means of threading or by means of a snap fit, has the important drawback that both fixations require a sealing to be applied between the neck portion and the valve assembly to ascertain air tightness. It is clear that such sealing increases both material and assembly cost. Moreover, the introduction of a seal also increases contamination risks. Indeed, at the interface between the sealing and the neck portion or the valve assembly, small cracks or splits may occur which are difficult if not impossible to disinfect.

Another drawback of applying threads or snap fits is that it necessitates special design of both the neck portion and the valve assembly, as they need to be provided with a treaded portion of with rims and flexible tines to allow a snap fit engagement between both parts. Such special design features increase material cost and weight of the container.

Fixation of the valve assembly to the neck portion by welding is another option, but has the important drawback that by the heat generation the welded material tends to flow, thereby creating a unevenness in the container that again, is increases contamination risks due to increased disinfection difficulty. It will be appreciated that since material flow due to heat occurs far more rapid with thermoplastic materials than with steel, applying laser techniques for fixing the valve assembly to a thermoplastic neck portion of a container will even increase contamination risk.

### SUMMARY OF THE INVENTION

In order to meet the above drawbacks, the present invention is directed to a method for fixing a valve assembly to a container, the container comprising a neck portion in a first thermoplastic material and the valve assembly comprising a ring of a second thermoplastic material, the method comprising positioning the valve assembly on or in the containers neck portion to form an interface between the thermoplastic ring and the containers neck portion, characterized in that the method further comprises laser welding the thermoplastic ring to the containers neck portion.

### DETAILED DESCRIPTION OF THE INVENTION

In accordance with the present invention it has been surprisingly found that by laser welding the interface, material flow inside the container can be limited or even avoided, while ensuring a sealing connection between the containers neck portion and the valve assembly. Hence, the inner surface of the container remains smooth and no slits or cracks are formed on the interface, facilitating disinfection of the container.

Another advantage of the present invention is that the fixation of the valve assembly by welding is irreversible and thus tamperproof, which is not the case if fixation is achieved by a thread or by a snap fit.

Preferably, the valve assembly is positioned in the neck portion of the container, which neck portion is manufactured in a thermoplastic material that allows transmittance of light with a wave length corresponding to that of laser, while the valve assembly or at least said thermoplastic ring is manufactured in a material that absorbs light with a wave length corresponding to that of laser light.

In this preferred method, the valve assembly can be positioned in the containers neck portion to form an interface between the thermoplastic ring and the containers neck portion, where after a laser beam is directed through the material of the containers neck portion on said interface to thereby melt interfacial thermoplastic material and form a weld between said finish and said valve assembly.

More preferably, the thermoplastic material of the containers neck portion absorbs light with a wavelength in the visual spectrum. The advantage hereof is that visible light can not penetrate through the container and affect a product, such as a beverage as beer, stored therein.

### INTRODUCTION TO THE DRAWINGS

FIG. 1 represents a containers neck portion with a valve assembly fixed therein.

### DETAILED DESCRIPTION OF A PREFERRED EMBODIMENT

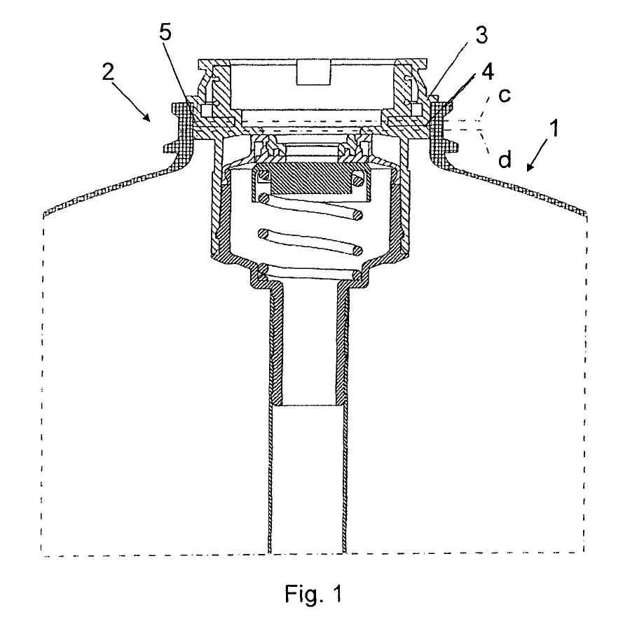

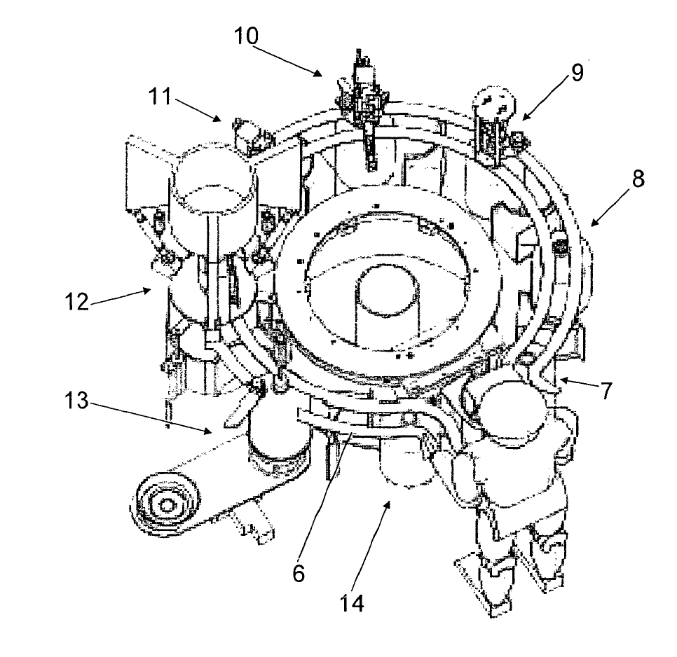

FIG. 1 represents a container or keg 1 having a neck finish or neck portion 2 with a valve assembly 3 fixed therein. According to the invention, at least the neck portion 2 of the keg 1 is manufactured in a first thermoplastic material. In the represented embodiment, the entire keg is manufactured in said first thermoplastic material.

Said first thermoplastic material preferably comprises a polyester, and more preferably one or more of polyethylene terephthalate (PET), polyethylene naphthalate (PEN) or PETN or mixtures thereof. Under prevailing economics, PET is preferred for one way keg applications, while PEN can be employed for returnable kegs where the cost discounting associated with multiple uses of the PEN keg can support the higher initial cost with its superior inherent gas properties can be written off over a longer useful life of the keg.

The first thermoplastic material preferably further comprises from about 0.5% to about 3.5% of a commercially available (brown) colorant. The addition of the colorant provides for light absorbing properties, especially for visible light with wavelengths below 650 nm. Particularly the neck portion and the first thermoplastic material have a transmittance of less than 15% at wavelengths below 650 nm and less than 5% between 600 nm to about 300 nm.

A variety of colorants may be employed to useful effect in this connection, including yellow, orange, green and brown. In an especially preferred form of the present invention, the first thermoplastic material has a transmittance of less than 3% at wavelengths of between 560 nm and 300 nm. Examples of such polyesters, in general, would include those comprising about 0.5 to about 3.5% brown colorant—such as that which is used commercially in the production of brown colored plastic beer bottles. Ranges of about 1 and 2% of said brown color are preferred, and about 1.5% of said brown color is particularly advantageous.

The advantage of using a first thermoplastic material with low transmittance for light with a wavelength below 650 nm is particularly relevant for containers or kegs used to store beverages such as for example beer, that are vulnerable to skunky thiol production under influence of light with above mentioned wavelengths. As is well known and accepted in the malt beverage brewing art, subjecting a hopped malt brewery beverage, especially an alcoholic hopped malt brewery beverage, such as, lager, ale, porter, stout, and the like (herein generically referred to as “beer”) to sunlight or artificial light results in a significantly deleterious effect on the sensory qualities of the beverage by generating a so-called “skunky” flavor, which is sometimes also referred to as “sun struck” or “light struck” flavor. It is believed that the skunky flavor is due to photochemical changes in the beverage that produce volatile sulfur-containing compounds (e.g. certain thiols). These sulfur compounds are thought to be formed at least in part by reaction of other sulfur-containing compounds with photochemically degraded hop components in the beverage. Only extremely minor concentrations of these sulfur compounds are required to be present to impart the skunky flavor to the beverage and render it unacceptable. The photochemical reaction is assisted by the presence of riboflavin, one of several photo-initiators in the beverage, the riboflavin emanating mainly from the malt used in the production of beer and to a minor extent via the hops and, according to the common wisdom, the action of yeast during the fermentation (See Tamer et al. Enzyme Microb Technology 10:754 756 (December, 1988)).

As will be appreciated, the appended drawing represents a preferred embodiment, wherein the valve assembly 3 is fitted within the neck portion 2. In this case, and in accordance with the present invention, the neck portion and the first thermoplastic material are preferably transparent for laser light (wavelengths from about 800 nm to about 1000 nm). A transmittance at a wave length of 980 nm, of greater than 40% up to about 70% or more is desired, while typically, useful first thermoplastic materials would have a transmittance at a wave length of 980 nm of between 50% and 66% and more particularly, between about 54% and 60%.

Thermoplastic materials having a transmittance of greater than 50, up to 66% over the broader range of wavelengths from 850 nm to 1050 nm are particularly preferred. In the present embodiment, the first thermoplastic material does not contain carbon black.

The neck portion typically has a thickness of about 6 mm.

Turning now to the valve assembly, it is noted that, according to the present invention, said assembly 3 comprises a ring 4 manufactured in a second thermoplastic material. Said ring 4 is situated at the outer periphery of said valve assembly 3 and has dimensions such that when the valve assembly 3 is positioned in the kegs neck portion 2, the ring 4 is in contact with the inner surface of the neck portion 2, thereby forming an interface 5 between the neck portion and the valve assembly 3, entirely circumscribing the valve assembly 3.

In the present embodiment, the entire valve body is made out of the second thermoplastic material.

The second thermoplastic material preferably comprises one or more of PET, PEN or PETN and further comprises a differential colorant adapted to increase the absorbance of laser light, i.e. light with wavelengths from about 800 nm to about 1000 nm

The differential colorant can for example be a carbon black colorant included in the second thermoplastic material in a range from 1% to 3%.

According to the present invention, the valve assembly 3 can be fixed in the containers neck portion 2 by a method comprising laser welding. The method according to the invention essentially comprises positioning the valve assembly 3 in the containers neck portion 2, such that the ring of second thermoplastic material is in contact with the inner surface of the neck portion 2, thereby forming an interface 5 between the thermoplastic ring 4 and the containers neck portion 2.

Subsequently a source of laser light is directed through the first thermoplastic material of said neck portion 2, onto said interface 5 to thereby melt the interfacial thermoplastic material and form a weld between the valve assembly 3 and the neck portion 2. The weld comprising melted, re-solidified thermoplastic material. The weld hereby seals the containers 1 interior.

In accordance with the preferred practice of the present invention, a valve body is inserted positioned into a keg neck, so that the respective surfaces of the neck to be welded to one another are engaged in mutually contacting relation.

The valve body is made of either PET or PEN thermoplastics, and is colored with from about 1 to about 3% of a commercial available carbon black colorant, (to provide for a higher differential absorption of laser energy during the welding steps described herein below).

In carrying out the welding operation, it is preferred to employ laser light having a wavelength of as low as about 808 nm, up to about 1050 nm. More particularly, it is preferred to use a laser light having a wavelength of greater than about 850 nm, and especially one having a waver length of about 980 nm.

The interface 5 is laser welded between lines of c and d, as shown in the appended drawing, by focusing the source of light, i.e. the laser beam, to the desired welding area. The laser welding is conducted by passing the laser beam through the neck portion 2 of the keg 1 between the indicated lines c and d and onto the target valve body—with the beam traveling at a liner rate of preferably 500 to 3000 mm/min, which is sufficient to effect the necessary weld but not imparting so much energy as to overly melt either along the weld line, or any substantial intervening material in the neck portion 2 itself. Control of the laser power is achieved by the use of a pyrometer to measure the temperature at the current weld point. The power supplied to the laser can therefore be adjusted to achieve and maintain the appropriate weld temperature.

As a result of the above described method according to the invention, a weld is obtained without or with very limited material flow next to the interface. Hence, the interior of the container, especially directly next to the weld remains smooth easy to disinfect. Moreover, the laser weld is not reversible and allows adequate sealing of the containers interior, thereby offering the additional advantages of tamperproof and safety, as the valve assembly can not be loosened from the container without severe effort. The weld further offers the advantage that the valve assembly can not pup out of the container when an overpressure is created therein, which is an important safety feature for containers for storing carbonated beverages such as beer.

In an alternative embodiment, the valve assembly, shaped as an inverted truncated conical valve body, is fitted into a co-operative opening in the neck portion 2 which is tapered to receive the conical side walls of the valve assembly in nested inter-fitting relation. A loading/clamping force is applied to urge the valve body into engagement with the neck portion 2, to deform the interfacial surfaces of the neck portion and the valve assembly, in compensation for any minor dimensional variations between them. With the applied force holding the neck portion and valve assembly engaged, light from an array of laser diodes is applied using a light guide to provide a constant illumination over the interface. When sufficient energy has been supplied to achieve the desired weld, lasing is discontinued, and the clamping force relieved once the thermoplastic weld has sufficiently solidified.

FIG. 2 schematically represents a container assembly process including a process step of fixing a valve onto the container by a method according the present invention.

This assembly process is achieved along a conveyor 6 having several working stations positioned adjacent thereto.

A first working station 7 for feeding containers on the conveyor 6. A second working station 8 for providing a valve assembly 3 in the containers neck portion 2 and a third working station for forcing the valve assembly 3 in a correct position for laser welding. It will be appreciated that the first and second working stations are well known in the art and do not need any further detailed description. The third working station 9 preferably comprises a load cell fixed onto a pneumatic cylinder (both not shown). The load cell is preferably coupled to control unit allowing monitoring the displacement of the valve assembly upon activation of the pneumatic cylinder and as such to ascertain that the valve assembly is forced in a correct position for laser welding.

A fourth working station 10 comprises a laser light source for laser welding the valve assembly 3 onto the containers neck portion 2. Optionally a fifth working station 11 is provided comprising a camera for controlling the quality of the weld between the valve assembly and the neck portion.

Once the valve assembly 3 is welded onto the container 1, and the weld controlled, the container is conveyed to a sixth working station 12, where the container is flushed with CO2 and pressurized (to for example 3.50 bar). In a seventh working station 13, a bottom chime is provided at the base of the container. Optionally this station also allows providing a upper chime to the top part of the container, thereby finalizing the container assembly. Finally, in a eight working station 14, the containers are rejected from the conveyer.

It is clear that the sixth, seventh and eight working stations 12, 13 and 14 are well known for a person skilled in the art and do not necessitate any further detailed description.

It is clear that the above assembly process is merely exemplar and can be executed according to various alternatives without leaving the scope of the present invention.

1. A method for fixing a valve assembly to a container, the container comprising a neck portion in a first thermoplastic material and the valve assembly comprising a ring of a second thermoplastic material, the method comprising positioning the valve assembly on or in the containers neck portion to form an interface between the thermoplastic ring and the containers neck portion, characterized in that the method further comprises laser welding the thermoplastic ring to the containers neck portion.

2. The method according to claim 1, characterized in that it comprises directing a laser beam through the thermoplastic material of the neck portion onto the interface.

3. The method according to claim 1, characterized in that the first thermoplastic material has a transmittance of at least 40% at a wave length of laser light.

4. A method for fixing a valve assembly to a container, the container comprising a neck portion in a first thermoplastic material and the valve assembly comprising a ring of a second thermoplastic material, the method comprising positioning the valve assembly in the containers neck portion to form an interface between the thermoplastic ring and the containers neck portion, characterized in that the method further comprises directing a laser beam through the material of the containers neck portion on said interface to thereby melt interfacial thermoplastic material and form a weld between said neck portion and said valve assembly.

5. A container manufactured according the method as identified in claim 1, characterized in that the container comprises a neck portion comprising polyester.

6. The container according to claim 5, characterized in that said polyester is selected from the group comprising PET, PEN and PETN polyesters.

7. The container according to claim 5, characterized in that the neck portion has a transmittance of at least 40% at a wave length of laser light.

8. The container according to any of claim 5, characterized in that the neck portion has a transmittance of less than 15% for wavelengths below 650 nm.

9. The container according to claim 5, characterized in that the neck portion has a transmittance of less than 5% for wavelengths between 600 nm and about 300 nm

10. The container according to claim 5, characterized in that the neck portion has a transmittance of less than 3% for wavelengths between 560 nm and about 300 nm.

11. A container manufactured according the method as identified in claim 4, characterized in that the container comprises a neck portion comprising polyester.

12. The container according to claim 6, characterized in that the neck portion has a transmittance of at least 40% at a wave length of laser light.

13. The container according to claim 6, characterized in that the neck portion has a transmittance of less than 15% for wavelengths below 650 nm.

14. The container according to claim 6, characterized in that the neck portion has a transmittance of less than 5% for wavelengths between 600 nm and about 300 nm

15. The container according to claim 6, characterized in that the neck portion has a transmittance of less than 3% for wavelengths between 560 nm and about 300 nm.

16. The container according to claim 7, characterized in that the neck portion has a transmittance of at least 40% at a wave length of laser light.

17. The container according to claim 7, characterized in that the neck portion has a transmittance of less than 15% for wavelengths below 650 nm.

18. The container according to claim 7, characterized in that the neck portion has a transmittance of less than 5% for wavelengths between 600 nm and about 300 nm

19. The container according to claim 7, characterized in that the neck portion has a transmittance of less than 3% for wavelengths between 560 nm and about 300 nm.
